(19) United States
(12) Patent Application Publication
(10) Pub. No.: US 2009/0204893 A1
(43) Pub. Date: Aug. 13, 2009

(54) DYNAMICALLY CONFIGURABLE PAGE NUMBERING SYSTEM

(76) Inventors: Truc NGUYEN, San Diego, CA (US); Katie Kuwata, Oceanside, CA (US); William Su, Riverside, CA (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 12/193,545

(22) Filed: Aug. 18, 2008

Related U.S. Application Data
(63) Continuation-in-part of application No. 10/205,307, filed on Jul. 24, 2002, now abandoned.
Application No. 10/205,307 is a continuation-in-part of application No. 11/769,416, filed on Jun. 27, 2007.
Application No. 11/769,416 is a continuation-in-part of application No. 11/252,485, filed on Oct. 18, 2005, now abandoned.
Application No. 11/252,485 is a continuation-in-part of application No. 10/205,307, filed on Jul. 24, 2002, now abandoned.
Application No. 10/205,307 is a continuation-in-part of application No. 10/201,886, filed on Jul. 24, 2002.
Application No. 10/201,886 is a continuation-in-part of application No. 10/157,525, filed on May 28, 2002, now abandoned.

(51) Int. Cl. G06F 17/00

(52) U.S. Cl. 715/251

(57) ABSTRACT

A system and method for dynamically configuring page numbers. A user is prompted for pagination data, including page number, pagination formatting, and pagination location for each page of a rendition of a document, via a thin client interface on a workstation. A document image data file comprising a bitmapped electronic document associated with the pagination data is then retrieved. An object file is populated with numbering data specified by the pagination data. The object and document files are communicated to a document rendering device that processes the object file to generate bitmapped pagination content. A merged file is created from bitmapped content of the image file and pagination content from the object file. A document output is generated from the merged file having viewable content including the content of the document data image file and the populated object file. The document output is communicated to the rendering device for rendering.

### CROSS-REFERENCE TO RELATED APPLICATIONS

This application is a Continuation-In-Part of U.S. application Ser. No. 10/205,307, filed on Jul. 24, 2002, the contents of which are incorporated herein by reference. This application also is a Continuation-In-Part of U.S. application Ser. No. 11/769,416, filed on Jun. 27, 2006, which is a Continuation-In-Part of U.S. application Ser. No. 11/252,485, filed on Oct. 18, 2005, which is a Continuation-In-Part of U.S. application Ser. No. 10/205,307, filed on Jul. 24, 2002, U.S. application Ser. No. 10/201,886, filed on Jul. 24, 2002, and U.S. application Ser. No. 10/157,525, filed on May 28, 2002, the contents of all which are incorporated herein by reference.

### BACKGROUND OF THE INVENTION

The subject application is directed to a system and method for dynamically configuring page numbers. More particularly, the subject application is directed to system and method for manipulating page numbers in an electronic document.

Earlier systems for page numbering comprised superimposing bitmaps on the document image. That is, a document is overlaid with a bitmap file containing a page number. After the document is overlaid with the bitmap file, an image is produced that comprises the original document with the page number. The bitmap file that is overlayed on the document may include an outline of the page or may cover the entire page of the document.

In order to delete a page number in the earlier systems, the system would white out the border around the document to remove the page number. Modifying a page number would require first deleting the original page number, and then superimposing another bitmap on the document image. As the earlier systems stored the page numbers as bitmaps to be superimposed on the document, page number attributes and properties of the media, as well as any other useful information associated therewith, could not be stored.

### SUMMARY OF THE INVENTION

In accordance with one embodiment of the subject application, there is provided a system and method for dynamically configuring page numbers. An associated user is first prompted for pagination data via a thin client interface on an associated, networked workstation. The pagination data suitably includes data representing a page number, pagination formatting, and pagination location on each of a plurality of pages of a rendition of an associated, electronic document. Pagination data is then received from the associated user via the thin client interface. An associated document image data file is then retrieved, which file represents a bitmapped electronic document associated with the pagination data. An object file is then populated on the workstation via the thin client interface with numbering data specified by the pagination data. The object file and the document image data file are then communicated via a network interface to an associated document rendering device. The document rendering device then processes the object file received from the associated workstation so as to generate bitmapped pagination content. A merged file is then created by merging bitmapped content of the document data image file with pagination content processed from the populated object file via the document rendering device, wherein the merged file includes document image data as retrieved. A document output is then generated from the merged file having viewable content that includes the content of the document data image file and the populated object file. Thereafter, the generated document image output is communicated to an associated document rendering device for rendering.

Still other advantages, aspects and features of the subject application will become readily apparent to those skilled in the art from the following description wherein there is shown and described a preferred embodiment of the subject application, simply by way of illustration of one of the best modes best suited to carry out the subject application. As it will be realized, the subject application is capable of other different embodiments and its several details are capable of modifications in various obvious aspects all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall diagram of a system for dynamically configuring page numbers according to one embodiment of the subject application;

FIG. 2 is a block diagram illustrating device hardware for use in the system for dynamically configuring page numbers according to one embodiment of the subject application;

FIG. 3 is a functional diagram illustrating the device for use in the system for dynamically configuring page numbers according to one embodiment of the subject application;

FIG. 4 is a block diagram illustrating controller hardware for use in the system for dynamically configuring page numbers according to one embodiment of the subject application;

FIG. 5 is a functional diagram illustrating the controller for use in the system for dynamically configuring page numbers according to one embodiment of the subject application;

FIG. 6 is a diagram illustrating a workstation for use in the system for dynamically configuring page numbers according to one embodiment of the subject application;

FIG. 7 is a functional block diagram illustrating an example of the system for dynamically configuring page numbers according to one embodiment of the subject application;

FIG. 8 is a screen template illustrating a graphical user interface for use in the system for dynamically configuring page numbers according to one embodiment of the subject application;

FIG. 9 is a flowchart illustrating a method for dynamically configuring page numbers according to one embodiment of the subject application; and

FIG. 10 is a flowchart illustrating a method for dynamically configuring page numbers according to one embodiment of the subject application.

### DETAILED DESCRIPTION OF THE PREFERRED EMBODIMENT

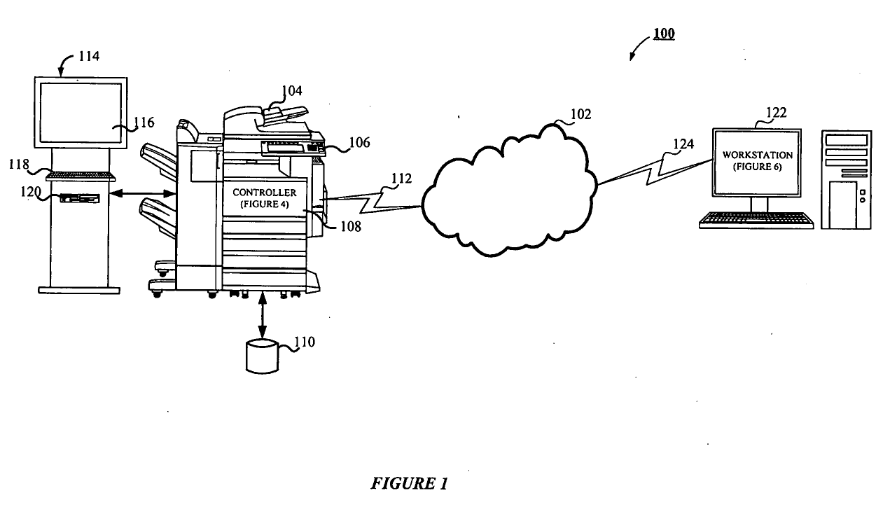

The subject application is directed to a system and method for dynamically configuring page numbers. More particularly, the subject application is directed to a system and method that allows a user to manipulate page numbers in a post-ripped multiple-page electronic document. It will become apparent to those skilled in the art that the system and method described herein are suitably adapted to a plurality of varying electronic fields employing extensible markup language documents, including, for example and without limitation, communications, general computing, data processing, document processing, or the like. The preferred embodiment, as depicted in FIG. 1, illustrates a document processing field for example purposes only and is not a limitation of the subject application solely to such a field.

Referring now to FIG. 1, there is shown an overall diagram of a system 100 for dynamically configuring page numbers in accordance with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or the any suitable combination thereof. In accordance with the preferred embodiment of the subject application, the computer network 102 is comprised of physical layers and transport layers, as illustrated by the myriad of conventional data transport mechanisms, such as, for example and without limitation, Token-Ring, 802.11(x), Ethernet, or other wireless or wire-based data communication mechanisms. The skilled artisan will appreciate that while a computer network 102 is shown in FIG. 1, the subject application is equally capable of use in a stand-alone system, as will be known in the art.

The system 100 also includes a document rendering device 104, depicted in FIG. 1 as a multifunction peripheral device, suitably adapted to perform a variety of document processing operations. It will be appreciated by those skilled in the art that such document processing operations include, for example and without limitation, facsimile, scanning, copying, printing, electronic mail, document management, document storage, or the like. Suitable commercially available document rendering devices include, for example and without limitation, the Toshiba e-Studio Series Controller. In accordance with one aspect of the subject application, the document rendering device 104 is suitably adapted to provide remote document processing services to external or network devices. Preferably, the document rendering device 104 includes hardware, software, and any suitable combination thereof, configured to interact with an associated user, a networked device, or the like.

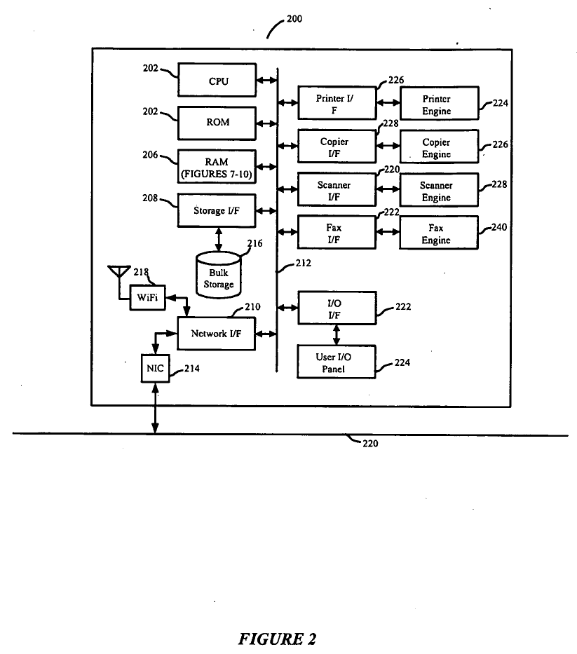

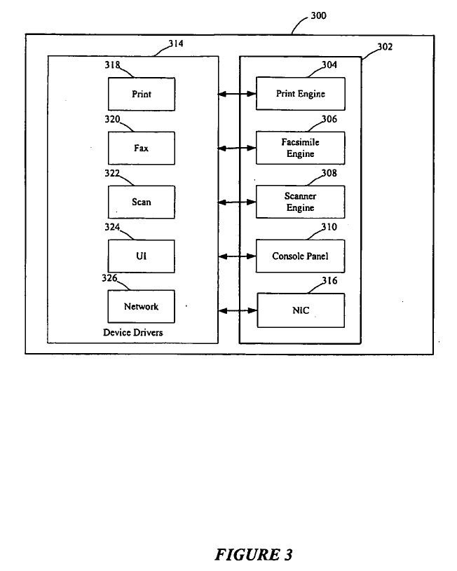

According to one embodiment of the subject application, the document rendering device 104 is suitably equipped to receive a plurality of portable storage media, including, without limitation, Firewire drive, USB drive, SD, MMC, XD, Compact Flash, Memory Stick, and the like. In the preferred embodiment of the subject application, the document rendering device 104 further includes an associated user interface 106, such as a touch-screen, LCD display, touch-panel, alpha-numeric keypad, or the like, via which an associated user is able to interact directly with the document rendering device 104. In accordance with the preferred embodiment of the subject application, the user interface 106 is advantageously used to communicate information to the associated user and receive selections from the associated user. The skilled artisan will appreciate that the user interface 106 comprises various components, suitably adapted to present data to the associated user, as are known in the art. In accordance with one embodiment of the subject application, the user interface 106 comprises a display, suitably adapted to display one or more graphical elements, text data, images, or the like, to an associated user, receive input from the associated user, and communicate the same to a backend component, such as a controller 108, as explained in greater detail below. Preferably, the document rendering device 104 is communicatively coupled to the computer network 102 via a suitable communications link 114. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art. The functioning of the document rendering device 104 will better be understood in conjunction with the block diagrams illustrated in FIGS. 2 and 3, explained in greater detail below.

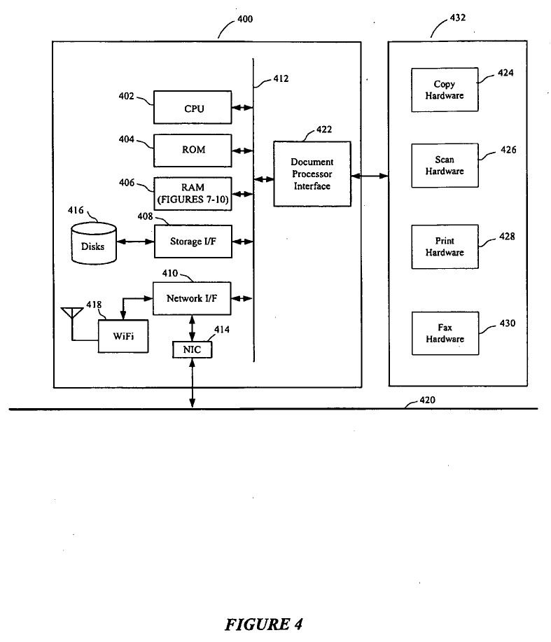

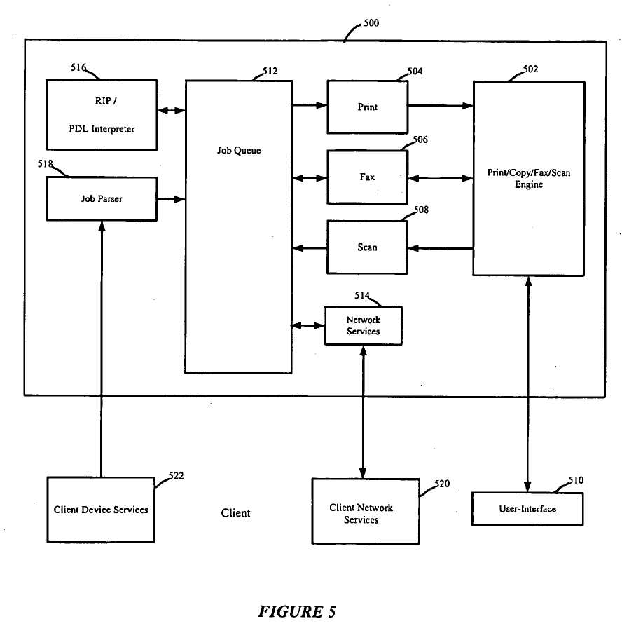

In accordance with one embodiment of the subject application, the document rendering device 104 further incorporates a backend component, designated as the controller 108, suitably adapted to facilitate the operations of the document rendering device 104, as will be understood by those skilled in the art. Preferably, the controller 108 is embodied as hardware, software, or any suitable combination thereof, configured to control the operations of the associated document rendering device 104, facilitate the display of images via the user interface 106, direct the manipulation of electronic image data, and the like. For purposes of explanation, the controller 108 is used to refer to any myriad of components associated with the document rendering device 104, including hardware, software, or combinations thereof, functioning to perform, cause to be performed, control, or otherwise direct the methodologies described hereinafter. It will be understood by those skilled in the art that the methodologies described with respect to the controller 108 are capable of being performed by any general purpose computing system, known in the art, and thus the controller 108 is representative of such a general computing device and is intended as such when used hereinafter. Furthermore, the use of the controller 108 hereinafter is for the example embodiment only, and other embodiments, which will be apparent to one skilled in the art, are capable of employing the system and method for dynamically configuring page numbers of the subject application. The functioning of the controller 108 will better be understood in conjunction with the block diagrams illustrated in FIGS. 4 and 5, explained in greater detail below.

Communicatively coupled to the document rendering device 104 is a data storage device 110. In accordance with the one embodiment of the subject application, the data storage device 110 is any mass storage device known in the art including, for example and without limitation, magnetic storage drives, a hard disk drive, optical storage devices, flash memory devices, or any suitable combination thereof. In one embodiment, the data storage device 110 is suitably adapted to store scanned image data, modified image data, redacted data, user information, cellular telephone data, pre-set payment data, document data, image data, electronic database data, or the like. It will be appreciated by those skilled in the art that while illustrated in FIG. 1 as being a separate component of the system 100, the data storage device 110 is capable of being implemented as an internal storage component of the document rendering device 104, a component of the controller 108, or the like, such as, for example and without limitation, an internal hard disk drive, or the like. In accordance with one embodiment of the subject application, the data storage device 110 is capable of storing document processing instructions, usage data, user interface data, job control data, controller status data, component execution data, images, advertisements, user information, location information, output templates, mapping data, multimedia data files, fonts, and the like.

FIG. 1 also illustrates a kiosk 114 communicatively coupled to the document rendering device 104, and in effect, the computer network 102. It will be appreciated by those skilled in the art that the kiosk 114 is capable of being implemented as a separate component of the document rendering device 104, or as an integral component thereof. Use of the kiosk 114 in FIG. 1 is for example purposes only, and the skilled artisan will appreciate that the subject application is capable of implementation without the use of the kiosk 114. In accordance with one embodiment of the subject application, the kiosk 114 includes an associated display 116, and a user input device 118. As will be understood by those skilled in the art the kiosk 114 is capable of implementing a combination user input device/display, such as a touchscreen interface. According to one embodiment of the subject application, the kiosk 114 is suitably adapted to display prompts to an associated user, receive document processing instructions from the associated user, receive payment data, receive selection data from the associated user, and the like. Preferably, the kiosk 114 includes a magnetic card reader, conventional bar code reader, or the like, suitably adapted to receive and read payment data from a credit card, coupon, debit card, or the like.

The system 100 of FIG. 1 also includes a portable storage device reader 120, coupled to the kiosk 114, which is suitably adapted to receive and access a myriad of different portable storage devices. Examples of such portable storage devices include, for example and without limitation, flash-based memory such as SD, xD, Memory Stick, compact flash, CD-ROM, DVD-ROM, USB flash drives, or other magnetic or optical storage devices, as will be known in the art.

The system 100 illustrated in FIG. 1 further depicts a computer workstation 122, in data communication with the computer network 102 via a communications link 124. It will be appreciated by those skilled in the art that the computer workstation 122 is shown in FIG. 1 as a computer workstation for illustration purposes only. As will be understood by those skilled in the art, the computer workstation 122 is representative of any personal computing device known in the art, including, for example and without limitation, a laptop computer, a personal computer, a personal data assistant, a web-enabled cellular telephone, a smart phone, a proprietary network device, or other web-enabled electronic device. The communications link 124 is any suitable channel of data communications known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art.

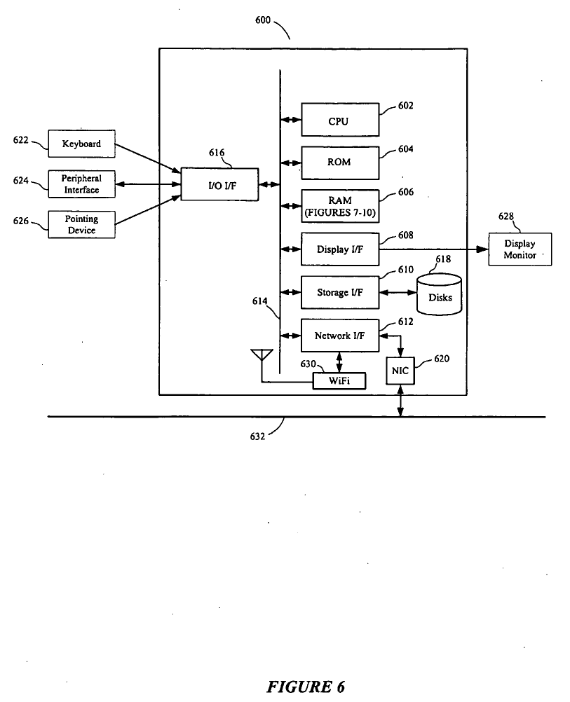

Preferably, the computer workstation 122 is suitably adapted to generate and transmit electronic documents, document processing instructions, user interface modifications, upgrades, updates, personalization data, or the like, to the document rendering device 104, or any other similar device coupled to the computer network 102. According to one embodiment of the subject application, the computer workstation 122 is suitably configured to employ a thin client interface, such as a web browser, for use in the system and method for dynamically configuring page numbers. The functioning of the computer workstation 122 will be better understood in conjunction with the block diagram of FIG. 6, discussed in greater detail below.

Turning now to FIG. 2, illustrated is a representative architecture of a suitable device 200 on which operations of the subject system are completed. Included is a processor 202, suitably comprised of a central processor unit. However, it will be appreciated that the processor 202 may advantageously be composed of multiple processors working in concert with one another as will be appreciated by one of ordinary skill in the art. Also included is a non-volatile or read only memory 204 which is advantageously used for static or fixed data or instructions, such as BIOS functions, system functions, system configuration data, and other routines or data used for operation of the device 200.

Also included in the device 200 is random access memory 206, suitably formed of dynamic random access memory, static random access memory, or any other suitable, addressable memory system. Random access memory provides a storage area for data instructions associated with applications and data handling accomplished by the processor 202.

A storage interface 208 suitably provides a mechanism for volatile, bulk or long term storage of data associated with the device 200. The storage interface 208 suitably uses bulk storage, such as any suitable addressable or serial storage, such as a disk, optical, tape drive and the like as shown as 216, as well as any suitable storage medium as will be appreciated by one of ordinary skill in the art.

A network interface subsystem 210 suitably routes input and output from an associated network allowing the device 200 to communicate to other devices. The network interface subsystem 210 suitably interfaces with one or more connections with external devices to the device 200. By way of example, illustrated is at least one network interface card 214 for data communication with fixed or wired networks, such as Ethernet, token ring, and the like, and a wireless interface 218, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface card 214 is interconnected for data interchange via a physical network 220, suitably comprised of a local area network, wide area network, or a combination thereof.

Data communication between the processor 202, read only memory 204, random access memory 206, storage interface 208 and the network subsystem 210 is suitably accomplished via a bus data transfer mechanism, such as illustrated by bus 212.

Suitable executable instructions on the device 200 facilitate communication with a plurality of external devices, such as workstations, document rendering devices, other servers, or the like. While, in operation, a typical device operates autonomously, it is to be appreciated that direct control by a local user is sometimes desirable, and is suitably accomplished via an optional input/output interface 222 to a user input/output panel 224 as will be appreciated by one of ordinary skill in the art.

Also in data communication with bus 212 are interfaces to one or more document processing engines. In the illustrated embodiment, printer interface 226, copier interface 228, scanner interface 230, and facsimile interface 232 facilitate communication with printer engine 234, copier engine 236, scanner engine 238, and facsimile engine 240, respectively. It is to be appreciated that the device 200 suitably accomplishes one or more document processing functions. Systems accomplishing more than one document processing operation are commonly referred to as multifunction peripherals or multifunction devices.

Turning now to FIG. 3, illustrated is a suitable document rendering device for use in connection with the disclosed system. FIG. 3 illustrates suitable functionality of the hardware of FIG. 2 in connection with software and operating system functionality as will be appreciated by one of ordinary skill in the art. The document rendering device 300 suitably includes an engine 302 which facilitates one or more document processing operations.

The document processing engine 302 suitably includes a print engine 304, facsimile engine 306, scanner engine 308 and console panel 310. The print engine 304 allows for output of physical documents representative of an electronic document communicated to the processing device 300. The facsimile engine 306 suitably communicates to or from external facsimile devices via a device, such as a fax modem.

The scanner engine 308 suitably functions to receive hard copy documents and in turn image data corresponding thereto. A suitable user interface, such as the console panel 310, suitably allows for input of instructions and display of information to an associated user. It will be appreciated that the scanner engine 308 is suitably used in connection with input of tangible documents into electronic form in bitmapped, vector, or page description language format, and is also suitably configured for optical character recognition. Tangible document scanning also suitably functions to facilitate facsimile output thereof.

In the illustration of FIG. 3, the document processing engine also comprises an interface 316 with a network via driver 326, suitably comprised of a network interface card. It will be appreciated that a network thoroughly accomplishes that interchange via any suitable physical and non-physical layer, such as wired, wireless, or optical data communication.

The document processing engine 302 is suitably in data communication with one or more device drivers 314, which device drivers allow for data interchange from the document processing engine 302 to one or more physical devices to accomplish the actual document processing operations. Such document processing operations include one or more of printing via driver 318, facsimile communication via driver 320, scanning via driver 322 and a user interface functions via driver 324. It will be appreciated that these various devices are integrated with one or more corresponding engines associated with the document processing engine 302. It is to be appreciated that any set or subset of document processing operations are contemplated herein. Document processors which include a plurality of available document processing options are referred to as multi-function peripherals.

Turning now to FIG. 4, illustrated is a representative architecture of a suitable backend component, i.e., the controller 400, shown in FIG. 1 as the controller 108, on which operations of the subject system 100 are completed. The skilled artisan will understand that the controller 400 is representative of any general computing device, known in the art, capable of facilitating the methodologies described herein. Included is a processor 402, suitably comprised of a central processor unit. However, it will be appreciated that processor 402 may advantageously be composed of multiple processors working in concert with one another as will be appreciated by one of ordinary skill in the art. Also included is a non-volatile or read only memory 404 which is advantageously used for static or fixed data or instructions, such as BIOS functions, system functions, system configuration data, and other routines or data used for operation of the controller 400.

Also included in the controller 400 is random access memory 406, suitably formed of dynamic random access memory, static random access memory, or any other suitable, addressable and writable memory system. Random access memory provides a storage area for data instructions associated with applications and data handling accomplished by processor 402.

A storage interface 408 suitably provides a mechanism for non-volatile, bulk or long term storage of data associated with the controller 400. The storage interface 408 suitably uses bulk storage, such as any suitable addressable or serial storage, such as a disk, optical, tape drive and the like as shown as 416, as well as any suitable storage medium as will be appreciated by one of ordinary skill in the art.

A network interface subsystem 410 suitably routes input and output from an associated network allowing the controller 400 to communicate to other devices. The network interface subsystem 410 suitably interfaces with one or more connections with external devices to the device 400. By way of example, illustrated is at least one network interface card 414 for data communication with fixed or wired networks, such as Ethernet, token ring, and the like, and a wireless interface 418, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 414 is interconnected for data interchange via a physical network 420, suitably comprised of a local area network, wide area network, or a combination thereof.

Data communication between the processor 402, read only memory 404, random access memory 406, storage interface 408 and the network interface subsystem 410 is suitably accomplished via a bus data transfer mechanism, such as illustrated by bus 412.

Also in data communication with bus the 412 is a document processor interface 422. The document processor interface 422 suitably provides connection with hardware 532 to perform one or more document processing operations. Such operations include copying accomplished via copy hardware 424, scanning accomplished via scan hardware 426, printing accomplished via print hardware 428, and facsimile communication accomplished via facsimile hardware 430. It is to be appreciated that the controller 400 suitably operates any or all of the aforementioned document processing operations. Systems accomplishing more than one document processing operation are commonly referred to as multifunction peripherals or multifunction devices.

Functionality of the subject system 100 is accomplished on a suitable document rendering device, such as the document rendering device 104, which includes the controller 400 of FIG. 4, (shown in FIG. 1 as the controller 108) as an intelligent subsystem associated with a document rendering device. In the illustration of FIG. 5, controller function 500 in the preferred embodiment includes a document processing engine 502. A suitable controller functionality is that incorporated into the Toshiba e-Studio system in the preferred embodiment. FIG. 5 illustrates suitable functionality of the hardware of FIG. 4 in connection with software and operating system functionality as will be appreciated by one of ordinary skill in the art.

In the preferred embodiment, the engine 502 allows for printing operations, copy operations, facsimile operations and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited purposes document rendering devices that are subset of the document processing operations listed above.

The engine 502 is suitably interfaced to a user interface panel 510, which panel allows for a user or administrator to access functionality controlled by the engine 502. Access is suitably enabled via an interface local to the controller, or remotely via a remote thin or thick client.

The engine 502 is in data communication with the print function 504, facsimile function 506, and scan function 508. These functions facilitate the actual operation of printing, facsimile transmission and reception, and document scanning for use in securing document images for copying or generating electronic versions.

A job queue 512 is suitably in data communication with the print function 504, facsimile function 506, and scan function 508. It will be appreciated that various image forms, such as bit map, page description language or vector format, and the like, are suitably relayed from the scan function 508 for subsequent handling via the job queue 512.

The job queue 512 is also in data communication with network services 514. In a preferred embodiment, job control, status data, or electronic document data is exchanged between the job queue 512 and the network services 514. Thus, suitable interface is provided for network based access to the controller function 500 via client side network services 520, which is any suitable thin or thick client. In the preferred embodiment, the web services access is suitably accomplished via a hypertext transfer protocol, file transfer protocol, uniform data diagram protocol, or any other suitable exchange mechanism. The network services 514 also advantageously supplies data interchange with client side services 520 for communication via FTP, electronic mail, TELNET, or the like. Thus, the controller function 500 facilitates output or receipt of electronic document and user information via various network access mechanisms.

The job queue 512 is also advantageously placed in data communication with an image processor 516. The image processor 516 is suitably a raster image process, page description language interpreter or any suitable mechanism for interchange of an electronic document to a format better suited for interchange with device functions such as print 504, facsimile 506 or scan 508.

Finally, the job queue 512 is in data communication with a parser 518, which parser suitably functions to receive print job language files from an external device, such as client device services 522. The client device services 522 suitably include printing, facsimile transmission, or other suitable input of an electronic document for which handling by the controller function 500 is advantageous. The parser 518 functions to interpret a received electronic document file and relay it to the job queue 512 for handling in connection with the afore-described functionality and components.

Turning now to FIG. 6, illustrated is a hardware diagram of a suitable workstation 600, shown in FIG. 1 as the administrative workstation 122, for use in connection with the subject system. A suitable workstation includes a processor unit 602 which is advantageously placed in data communication with read only memory 604, suitably non-volatile read only memory, volatile read only memory or a combination thereof, random access memory 606, display interface 608, storage interface 610, and network interface 612.

In a preferred embodiment, interface to the foregoing modules is suitably accomplished via a bus 614.

The read only memory 604 suitably includes firmware, such as static data or fixed instructions, such as BIOS, system functions, configuration data, and other routines used for operation of the workstation 600 via CPU 602.

The random access memory 606 provides a storage area for data and instructions associated with applications and data handling accomplished by the processor 602.

The display interface 608 receives data or instructions from other components on the bus 614, which data is specific to generating a display to facilitate a user interface. The display interface 608 suitably provides output to a display terminal 628, suitably a video display device such as a monitor, LCD, plasma, or any other suitable visual output device as will be appreciated by one of ordinary skill in the art.

The storage interface 610 suitably provides a mechanism for non-volatile, bulk or long term storage of data or instructions in the workstation 600. The storage interface 610 suitably uses a storage mechanism, such as storage 618, suitably comprised of a disk, tape, CD, DVD, or other relatively higher capacity addressable or serial storage medium.

The network interface 612 suitably communicates to at least one other network interface, shown as network interface 620, such as a network interface card, and wireless network interface 630, such as a WiFi wireless network card. It will be appreciated that by one of ordinary skill in the art that a suitable network interface is comprised of both physical and protocol layers and is suitably any wired system, such as Ethernet, token ring, or any other wide area or local area network communication system, or wireless system, such as WiFi, WiMax, or any other suitable wireless network system, as will be appreciated by one of ordinary skill in the art. In the illustration, the network interface 620 is interconnected for data interchange via a physical network 632, suitably comprised of a local area network, wide area network, or a combination thereof.

An input/output interface 616 in data communication with the bus 614 is suitably connected with an input device 622, such as a keyboard or the like. The input/output interface 616 also suitably provides data output to a peripheral interface 624, such as a USB, universal serial bus output, SCSI, Firewire (IEEE 1394) output, or any other interface as may be appropriate for a selected application. Finally, the input/output interface 616 is suitably in data communication with a pointing device interface 626 for connection with devices, such as a mouse, light pen, touch screen, or the like.

In accordance with one embodiment of the subject application, the system 100 provides a dynamically configurable page numbering system in which page numbers are treated as objects stored in XML files. The XML files store data representative of the page number, related attributes, and properties of the media on which the page number is to be printed. The present invention uses an object oriented architecture to process page numbers. The page number information is structured as one or more self-organized objects. The present invention also contemplates providing a user interface that allows a user to generate page number information that can be easily managed and provides functionality to insert, delete, copy, and edit page number information. All of the processes provided by the user interface are similar to the way in which text is handled in a standard word processor application.

The object oriented nature of this invention provides independent program modules written in an XML format that work together as a group at runtime without any prior linking or pre-compilation. Thus, the objects interoperate at runtime strictly through messages passed between them.

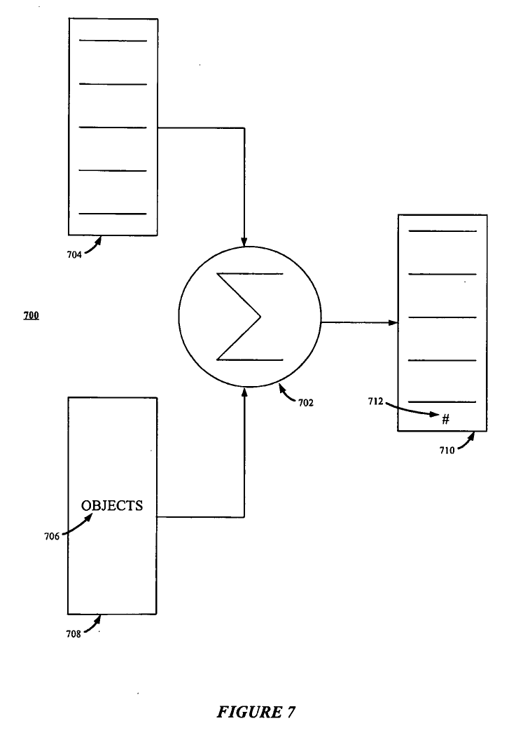

Referring now to FIG. 7, there is shown a block diagram 700 describing the interaction the various features of the present invention. A processor 702 acts as a summer to merge the document 704 with objects 706 stored in an object file 708. Typically, the object file 708 is an XML file and the objects 706 stored in the object file 708 are XML objects. After processing the document 704 and the object file 708, the processor 702 produces an output 710. The output comprising the document 704 and a page number 712 which is generated by processing the objects 706 stored in the object file 708.

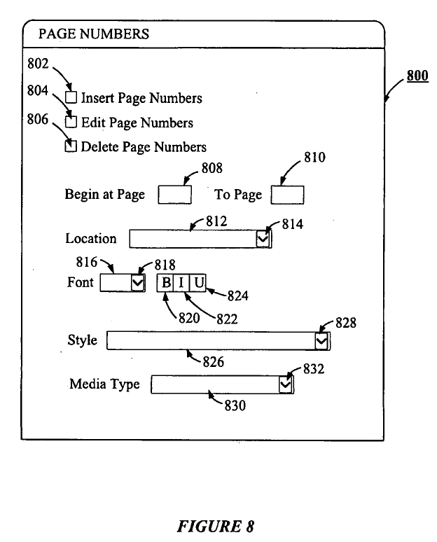

Referring now to FIG. 8, there is shown an example of a user interface 800. By selecting checkboxes 802, 804 or 806 a user can either insert page numbers, edit page numbers, or delete page numbers respectively. At box 808 the user would enter the page number of the document to start at and at box 810 the page number at which to stop. The location box 812 enables the user to specify the location on the page where the page number should be printed. A pre-selected list of locations can be accessed by selecting the arrow 814 next to the box 812. Box 816 enables the user to select the font for the page number. Arrow 818 can be used to allow the user to select a font from a pre-selected list. Pushbuttons 820, 822, and 824 enable the user to make the page numbers bold, italicized, or underlined respectively. Style box 826 enables the user to select various styles of page numbers, for example page 1 or 20, or the user can specify that the page numbers appear as Roman Numerals, Arabic Numbers, or other styles. Arrow 828 enables the user to select a style from a pre-selected list. Finally, the Media type can be entered in box 830 or arrow 832 can be used to select from pre-selected sizes such as Letter, A3, A4, etc. As FIG. 8 is an example of the preferred embodiment, the arrangement of the fields and the naming of the fields as limiting as those skilled in the art can readily appreciate that there are many alternatives available.

After the user enters the data into the user interface 800, the data is stored as objects 706 in the object file 708. What follows is an example of the objects 706 being stored in the object file as XML code:

<key name=″Page Number″>

<value name=″number″ type=″uint32″>2</value>
<value name=”display as page number”

type=”uint32”>1,</value>

<value name=″font″ type=″string″>Arial,10

point,Bold</value>

<value name=“position”

type=”string”>bottom,center</value>

<value name=”style” type=”string”>Arabic</value>
<value name=”media attributes”

type=”string”>letter</value>

</key>

Thus, at runtime when the processor 702 of an image forming apparatus (not shown) processes the document 704, the processor simultaneously processes the objects 706 in the object file 708. As shown in the above example, when the processor 702 prints page 2 of the document, it will display page number “1” in Arabic numerals, using an Arial 10 point bold font, at the bottom center of the page, the page being letter sized.

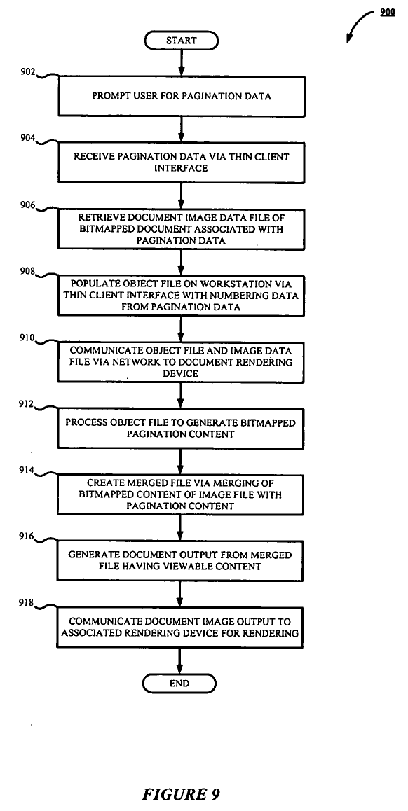

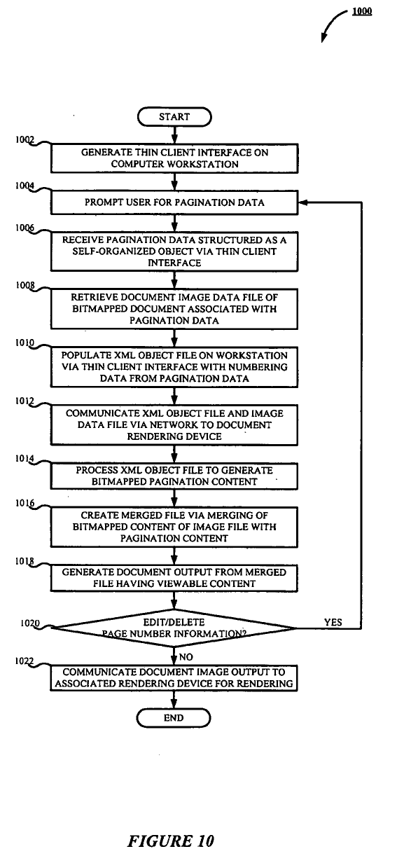

The skilled artisan will appreciate that the subject system 100 and components described above with respect to FIG. 1, FIG. 2, FIG. 3, FIG. 4, FIG. 5, FIG. 6, FIG. 7, and FIG. 8 will be better understood in conjunction with the methodologies described hereinafter with respect to FIG. 9 and FIG. 10. Turning now to FIG. 9, there is shown a flowchart 900 illustrating a method for dynamically configuring page numbers in accordance with one embodiment of the subject application. Beginning at step 902, an associated user is first prompted for pagination data via a thin client interface on the computer workstation 122. In accordance with one embodiment of the subject application, the pagination data prompted from the user includes, for example and without limitation, data representing a page number, pagination formatting and pagination location on each of a plurality of pages of a rendition of an associated, electronic document.

At step 904, the computer workstation 122 receives pagination data from the associated user via the thin client interface. It will be appreciated by those skilled in the art that a suitable thin client interface includes, for example and without limitation, a web browser, a dedicated graphical user interface, and the like. The computer workstation 122 then retrieves an associated document image data file representing a bitmapped electronic document associated with the pagination data at step 906. At step 908, an object file is populated on the associated workstation 122 via the thin client interface with numbering data specified by the pagination data.

The object file and the document image file are then communicated via a network interface to an associated document rendering device 104 at step 910. In accordance with one embodiment of the subject application, the object file and the document image file are communicated to the document rendering device 104 from the computer workstation 122 via the computer network 102. The controller 108 or other suitable component associated with the document rendering device 104 then processes the object file received from the computer workstation 122 at step 912 so as to generate bitmapped pagination content. At step 914, the controller 108 or other suitable component associated with the document rendering device 104 creates a merged file by merging bitmapped content of the document data image file with pagination content processed from the populated object file. In accordance with one embodiment of the subject application, the merged file further includes document image data as retrieved by the workstation 122.

At step 916, the controller or other suitable component associated with the document rendering device 104 generates a document output from the merged file having viewable content inclusive of the content of the document data image file and the populated object file. The generated document image output is then communicated at step 918 to an associated document rendering device 104 for rendering therefrom. That is, the controller 108 communicates the generated document image output to the document rendering engine or other suitable component associated with the document rendering device 104 for rendering therefrom. In accordance with one embodiment of the subject application, the workstation 122 facilitates the generation of the merged data such that the workstation communicates the document image output to the document rendering device 104 via the computer network 102.

Referring now to FIG. 10, there is shown a flowchart 1000 illustrating a method for dynamically configuring page numbers in accordance with one embodiment of the subject application. The methodology depicted in FIG. 10 begins at step 1002, whereupon a thin client interface is generated on the computer workstation 122 corresponding to a suitable interface for implementing page numbering configurations of an associated electronic document. In accordance with one embodiment of the subject application, the thin client interface is implemented as a web browser, a dedicated graphical user interface, or the like, such as the template interface illustrated in FIG. 8, discussed in greater detail above. Preferably, the thin client interface generated via the workstation 122 is comprised of independent modules written in a suitable markup language, e.g. eXtensible Markup Language (“XML”). It will be understood by those skilled in the art that while reference is made hereinafter to the workstation 122 for FIG. 10, such a workstation 122 is capable of representing a component of the document rendering device 104, the kiosk 114, the separate component 122, or any suitable combination thereof.

At step 1004, a user associated with the computer workstation 122 is prompted to input pagination data via the thin client interface. According to one embodiment of the subject application, the pagination data requested from the user includes, for example and without limitation, page numbers, pagination formatting, pagination location, pagination styles, fonts, size, and the like. Pagination data is then received from the associated user by the computer workstation 122 via the thin client interface at step 1006. In accordance with one embodiment of the subject application, the pagination data is structured as a self-organized object via the thin client interface, e.g. an XML object, as will be understood by those skilled in the art.

The computer workstation 122 then retrieves a document image data file of a bitmapped document associated with the pagination data at step 1008. That is, the workstation retrieves a document image file corresponding to an electronic document that is to incorporate the pagination data, as will be appreciated by those skilled in the art. At step 1010 an object file is populated on the computer workstation 122 via the thin client interface with numbering data from the received pagination data. In accordance with one embodiment of the subject application, the object file is an XML file, which includes, for example and without limitation, page number attributes, media data properties, and the like.

The XML object file and the image data file are then communicated at step 1012 from the computer workstation 122 to a selected document rendering device 104 via the computer network 102. The controller 108 or other suitable component associated with the document rendering device 104 then processes the received XML object file at step 1014, resulting in the generation of bitmapped pagination content. That is, the controller 108 processes the received objects in the XML object file and translates such code (see above) into bitmapped content. The bitmapped pagination content is then merged with bitmapped content of the document image data file by the controller 108 or other suitable component associated with the document rendering device 104 at step 1016 so as to create a merged file.

At step 1018, the controller 108 or other suitable component associated with the document rendering device 104 generates a document output having viewable content from the merged file, i.e. the merged bitmapped files. The skilled artisan will appreciate that such viewable content includes, for example and without limitation, page numbers on the electronic document, line numbers on the electronic document, reference marks on the electronic document, and the like. A determination is then made at step 1020 whether the user desires to edit or delete page number information. Upon a determination that the user desires to modify the page number information, flow returns to step 1004, whereupon the user is prompted for updated pagination information. Operations then continue in accordance with steps 1006-1018 as set forth above. When it is determined at step 1020 that no modifications to the page number information is desired, operations progress to step 1022, whereupon the document image output is communicated to the document rendering device 104 for rendering thereof.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

1. A method for dynamically configuring page numbers, the steps comprising:
prompting an associated user for pagination data via a thin client interface on an associated, networked workstation, which pagination data includes data representative of a page number, pagination formatting and pagination location on each of a plurality of pages of a rendition of an associated, electronic document;
receiving, from the associated user, pagination data via the thin client interface;
retrieving an associated document image data file representative of a bitmapped electronic document associated with the pagination data;
populating an object file on the associated workstation via the thin client interface with numbering data specified by the pagination data;
communicating the object file and the document image data file via a network interface to an associated document rendering device;
processing an object file on the associated document rendering device, so as to generate bitmapped pagination content, which object file is received from the associated workstation;
creating a merged file by merging bitmapped content of the document data image file with pagination content processed from the populated object file via the document rendering device, wherein the merged file includes document image data as retrieved;
generating a document output from the merged file having viewable content inclusive of the content of the document data image file and the populated object file; and
communicating the generated document image output to an associated document rendering device for rendering therefrom.

2. The method of claim 1 wherein the page number data is structured in at least one self-organized object.

3. The method of claim 1 wherein the object file is an XML file.

4. The method of claim 3, the XML file further comprising page number attribute and properties of media data.

5. The method of claim 1 wherein the thin client interface provides functionality to edit and delete the page number information.

6. The method of claim 5 wherein the thin client interface comprises independent modules written in XML.

7. A system for dynamically configuring page numbers, the steps comprising:
means adapted for prompting an associated user for pagination data via a thin client interface on an associated, networked workstation, which pagination data includes data representative of a page number, pagination formatting and pagination location on each of a plurality of pages of a rendition of an associated, electronic document;
means adapted for receiving, from the associated user, pagination data via the thin client interface;
means adapted for retrieving an associated document data image file representative of a bitmapped electronic document associated with the pagination data;
means adapted for populating an object file on the associated workstation via the thin client interface with numbering data specified by the pagination data;
means adapted for communicating the object file and the document image data file via a network interface to an associated document rendering device;
means adapted for processing an object file on the associated document rendering device, so as to generate bitmapped pagination content, which object file is received from the associated workstation;
means adapted for creating a merged file by merging content of the document image data file with pagination content processed from the populated object file via the document rendering device, wherein the merged file includes document image data as retrieved;
means adapted for generating a document output from the merged file having viewable content inclusive of content of the document data image file and the populated object file; and
means adapted for communicating the generated document image output to an associated document rendering device for rendering therefrom.

8. The system of claim 7 wherein the page number data is structured in at least one self-organized object.

9. The system of claim 7 wherein the object file is an XML file.

10. The system of claim 9, the XML file further comprising page number attribute and properties of media data.

11. The system of claim 7 wherein the thin client interface provides functionality to edit and delete the page number information.

12. The system of claim 11 wherein the thin client interface comprises independent modules written in XML.

13. A computer-readable medium of instructions having computer-readable instructions stored thereon for dynamically configuring page numbers, the steps comprising:
instructions for prompting an associated user for pagination data via a thin client interface on an associated, networked workstation, which pagination data includes data representative of a page number, pagination formatting and pagination location on each of a plurality of pages of a rendition of an associated, electronic document;
instructions for receiving, from the associated user, pagination data via the thin client interface;
instructions for retrieving an associated document image data file representative of a bitmapped electronic document associated with the pagination data;
instructions for populating an object file on the associated workstation via the thin client interface with numbering data specified by the pagination data;
instructions for communicating the object file and the document image data file via a network interface to an associated document rendering device;
instructions for processing an object file on the associated document rendering device, so as to generate bitmapped pagination content, which object file is received from the associated workstation;
instructions for creating a merged file by merging content of the document image data file with pagination content processed from the populated object file via the document rendering device, wherein the merged file includes document image data as retrieved;
instructions for generating a document output from the merged file having viewable content inclusive of the content of the document data image file and the populated object file; and
instructions for communicating the generated document image output to an associated document rendering device for rendering therefrom.

14. The computer-readable medium of instructions of claim 13 wherein the page number data is structured in at least one self-organized object.

15. The computer-readable medium of instructions of claim 13 wherein the object file is an XML file.

16. The computer-readable medium of instructions of claim 15, the XML file further comprising page number attribute and properties of media data.

17. The computer-readable medium of instructions of claim 13 wherein the thin client interface provides functionality to edit and delete the page number information.

18. The computer-readable medium of instructions of claim 17 wherein the thin client interface comprises independent modules written in XML.
